(19) United States
(12) Patent Application Publication
(10) Pub. No.: US 2013/0057068 A1
(43) Pub. Date: Mar. 7, 2013

(54) MOBILE BACKUP POWER SUPPLY DEVICE WITH A HUB'S FUNCTIONS INTEGRATED

(71) Applicant: SHIH-YAO LIN, New Taipei City (TW)

(72) Inventor: SHIH-YAO LIN, New Taipei City (TW)

(73) Assignee: SYSGRATION LTD.

(21) Appl. No.: 13/224,289

(22) Filed: Sep. 1, 2011

(51) Int. Cl. H02J 9/06

(52) U.S. Cl. 307/23

(57) ABSTRACT

A mobile backup power supply device includes a Hub with not less than one input port connected to a computer's power supply or an external electric power source and not less than an output port connected to an electronic device, both of which fulfill data transmission & management by means of a Hub control structure in order to deliver a Hub's functions; an electricity storage device inside the Hub which can be either primary batteries or secondary batteries and connected to a charge control structure used to link an external electric power source for the purpose of matching secondary batteries' characteristics during charge; a power management structure between the electricity storage device and the out port which is able to detect and automatically adjust electricity required by an external electronic device in order to stably and uniformly transmit electricity to an electronic device from the electricity storage device.

### BACKGROUND OF THE INVENTION

1. Field of the Invention

The present invention provides a mobile backup power supply device with a Hub's functions integrated, especially an easily movable backup power supply product which stores sufficient power used to charge a variety of portable electronic products simultaneously and featuring a Hub's functions.

2. Description of the Prior Art

With development of technologies, electronic products which are increasingly required and substantially appreciated by people have almost permeated through every aspect of our lives, for instance, household and social activities, work, entertainment, etc. In essence, those electronic products are being continuously designed and developed to thin and compact models due to progressive electronic technique in which people acquiring electronic technologies' real-time assistance for convenient lives make much of their portability in addition to powerful functions of these products encapsulated within limited space.

In such situations, all manufacturers are diligently making thorough studies of miniaturization about electronic products and have earned plentiful achievements rapidly in consideration of portability of any electronic product. On the other hand, the fast development of these electronic products, however, have also been restricted because of their inherent limitations, one of which is power supply that has been taken as one source of electricity used to drive an electronic product and substantially dominating a powerful product during any failure attributed to electricity shortage or suspension. In general, a user who possesses a conventional electronic product used in one fixed place and relying on domestic electricity usually neglects the issue of power supply. Comparatively, electricity as small as one milliampere, however, is referred to as a very precious resource for one portable product which is usually paralyzed by temporary electricity failure due to limited battery capacity when the technique of electricity storage is still one issue not effectively settled by those manufacturers making their efforts to study low-consumption technologies. For those electronic products increasingly thin and compact, their batteries' shrunk volumes particularly imply the battery capacity has become much insufficient and unfavorable to application of one portable electronic product.

For this matter, an outgoing user may choose to bring one charger which is confined to its volume or style difficultly stored and is not comparable to another portable electronic product but disturb himself (or herself) with two or more products as well as other miscellaneous articles carried. On the other hand, this user may bring another battery or a small-type generator as one backup power supply. However, the utilization of these devices is seldom because most people are unwilling to carry or inconveniently bring these devices which are inapplicable frequently but occupy limited personal space, or forget to take them in a hurry.

As previously mentioned, there are still some disadvantages existing in a portable backup power supply device manufactured in prior arts and need to be corrected.

In consideration of faults of those products manufactured in prior arts, the inventor did researches and carefully observe different models of portable electronic products on which there are some ports such as USB and IEEE 1394 used to link another electronic product or computer for data transmission and charge. As a result, the inventor collecting all useful ideas and depending on importance of ports not neglected by people provides users an external backup power source applicable to charging a personal portable electronic product anytime. Based on demand for convenience, the invention with a Hub integrated can be taken as not only a Hub but also a backup power supply. After long-tern research and practice, this mobile backup power supply device with a Hub's functions combined is successfully available.

### SUMMARY OF THE INVENTION

The principal object of the present invention is to provide a mobile backup power supply device with a Hub's functions integrated which features a simple, compact and portable structure and unique ports triggering a user's remembrance to bring the device as one tool charging a portable electronic product anytime.

The other object of the present invention is to provide a mobile backup power supply device with a Hub's functions integrated which serves and charges multiple portable electronic products and makes sure of sufficient electricity supplied to each of them.

The further object of the present invention is to provide a mobile backup power supply device with a Hub's functions integrated which serves and charges not only one single portable electronic product but also various portable electronic products.

The yet other object of the present invention is to provide a mobile backup power supply device with a Hub's functions integrated which is taken as a transmission interface between a portable electronic product and a computer owing to a combination of a Hub's functions.

The mobile backup power supply device with a Hub's functions integrated which is able to deliver the said objects comprises a Hub, an electricity storage device and a power management structure. The Hub is provided with not less than one input port connected to a computer's power supply or an external electric power source and not less than one output port connected to an external electronic device, both of which contributes to data transmission & management according to a Hub control structure for connection of a Hub. The electricity storage device installed inside the Hub could be chargeable secondary batteries such as Nickel-Cadmium battery, Nickel-Metal Hydride battery or Lithium Ion battery. In order to match characteristics of charge, the electricity storage device is connected to a charge control structure which is used to link an external electric power source. As primary batteries also, the electricity storage device allows its batteries to be replaced with its battery compartment opened during electricity exhausted. The power management structure connected between the electricity storage device and the output port is capable of detecting and automatically adjusting electricity required by an external electronic device in order to uniformly and stably deliver electricity to each electronic device from the electricity storage device. Both the input port and the output port have their pins classified into two types in general, power pins and data pins, wherein the power pins are used to connect the electricity storage device for backup electricity supplied to one external electronic device and the data pins are used to connect the Hub control structure which receives an external electronic device's demand for electricity via the data pins and adjusts the electricity storage device for export of stable power by means of the power management structure.

### BRIEF DESCRIPTION OF THE DRAWINGS

The drawings disclose an illustrative embodiment of the present invention which serves to exemplify the various advantages and objects hereof, and are as follows:

FIG. 1 is the perspective view of the present invention of a mobile backup power supply device with a Hub's functions integrated;

FIG. 2 is the block diagram for the mobile backup power supply device with a Hub's functions integrated;

FIGS. 3A˜H are schematic diagrams for structures of different types of USB ports;

FIGS. 3I˜K are schematic diagrams for structures of different types of IEEE 1394 ports;

FIG. 4 is the schematic diagram for the charge structure of the mobile backup power supply device with a Hub's functions integrated.

FIG. 5 is the block diagram for charge control of the mobile backup power supply device with a Hub's functions integrated;

FIG. 6 is the block diagram which illustrates an external electric power source is switched by the mobile backup power supply device with a Hub's functions integrated for supply of electricity;

FIG. 7 is the block diagram for the stable electric structure of the mobile backup power supply device with a Hub's functions integrated; and

FIG. 8 is the schematic diagram for the surplus electricity indicator of the mobile backup power supply device with a Hub's functions integrated.

### DETAILED DESCRIPTION OF THE PREFERRED EMBODIMENT

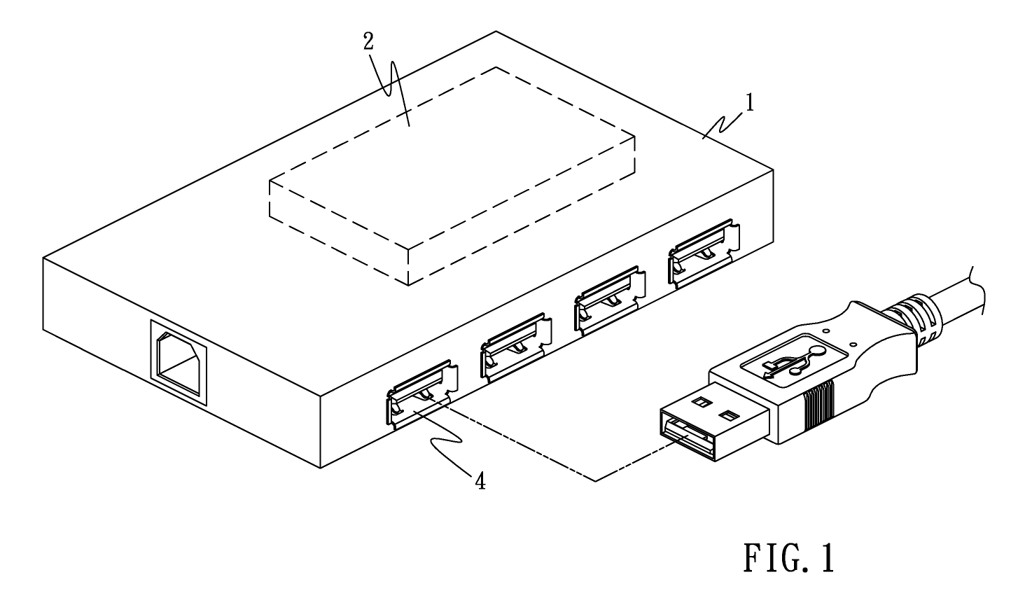

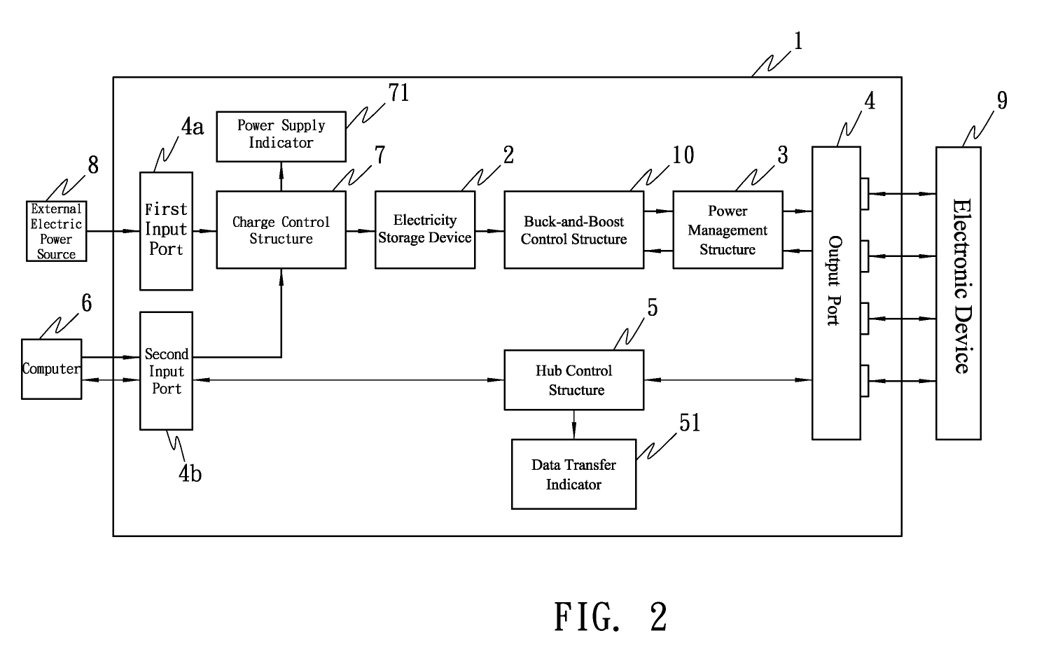

Referring to FIGS. 1 and 2 which illustrate the present invention of a mobile backup power supply device with a Hub's functions integrated comprising a Hub 1, an electricity storage device 2 and a power management structure 3.

The Hub 1 is provided with not less than a first input port 4a connected to a power supply of a computer 6 and not less than an output port 4 connected to another external electronic device 9, both of which complete data transmission & management by means of a Hub control structure 5 with its both ends linking the computer 6 and the external electronic device 9 in order to deliver a Hub's function for data transmission.

The electricity storage device 2 installed inside the Hub 1 could be chargeable secondary batteries such as Nickel-Cadmium (Ni—Cd) battery, Nickel-Metal Hydride (Ni-MH) battery or Lithium Ion (Li-Ion) battery. To match characteristics of charge, the electricity storage device 2 is connected to a charge control structure 7 which links the computer 6 via the first input port 4a (or additionally links an external electric power source 8 via a second input port 4b) in order to charge the electricity storage device 2 during electricity exhausted.

As primary batteries also, the electricity storage device 2 is provided with a battery compartment (not shown in the figure) for primary batteries accommodated. To match the secondary batteries, the primary batteries could be a variety of primary batteries such as Zinc-Manganese battery, Alkaline-Manganese battery, Zinc-air battery, Mercury battery, Silver Oxide battery, and Lithium battery with their sizes and quantities adjusted to required configurations, for example, AA*2 or AAA*2, which can be replaced by opening a battery compartment during electricity exhausted.

With an intelligent automatic management function, the power management structure 3 connected between the electricity storage device 2 and the output port 4 is capable of detecting and automatically adjusting electricity required by an electronic device 9 in order to uniformly and stably deliver electricity of the electricity storage device 2 to the electronic device 9 and keep the running electronic device 9 work safely.

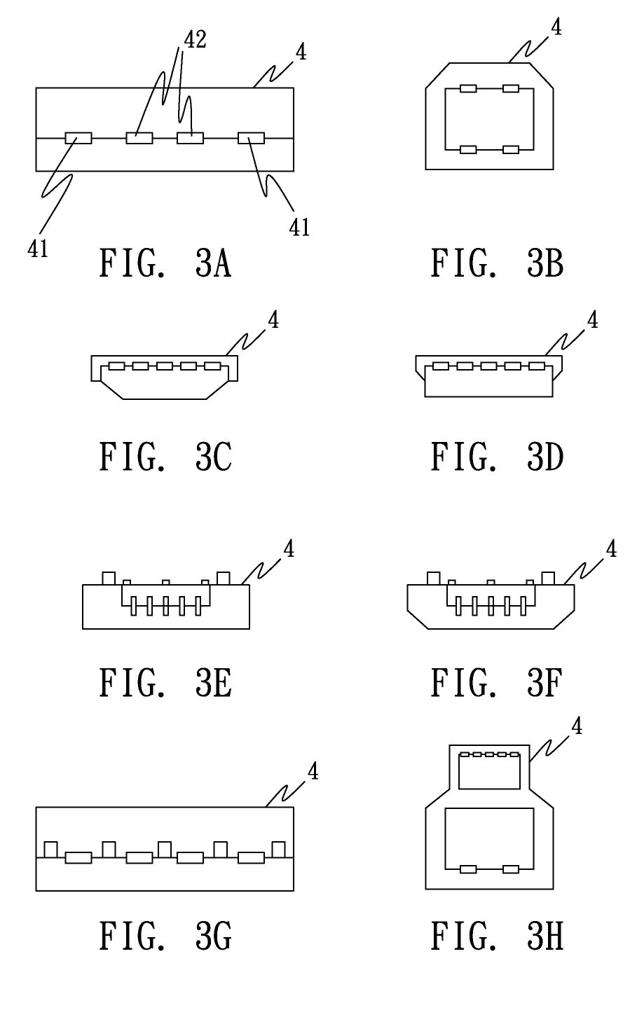

Referring to FIGS. 3A˜I which illustrate the first input port 4a, the second input port 4b and the output port 4 (as an example interpreted hereinafter) could be any model for data transmission and charge successfully delivered such as common USB port and IEEE 1394 port. The USB ports comprises several common models, for instance, a rectangular flat external, i.e., standard USB A Type (FIG. 3A); a square external, i.e., standard USB B Type (FIG. 3B); a shrunk volume, i.e., mini USB A/B (FIG. 3C/D); a much smaller volume applicable to a mobile device conveniently, i.e., micro USB A/B (FIG. 3E/F); or latest USB 3.0 A/B (FIG. 3G/H). The IEEE 1394 ports comprise initial models based on pins such as IEEE 1394a 6Pin (FIG. 3I) and IEEE 1394a 4Pin (FIG. 3J) as well as later models based on increased traffic such as IEEE 1394b 9Pin (FIG. 3K). In general, the models of the first input port 4a, the second input port 4b and the output port 4 without departing from demand for charge offered by the present invention are continuously added and corrected.

With a feature of automatically adjusted output power emphasized by the present invention, the output port 4, e.g., USB port (FIG. 3A), is provided with internal pins classified into power pins 41 and data pins 42 generally wherein the power pins 41 are connected to the electricity storage device 2 for electricity offered to a backup electric power supply and the data pins 42 are connected to the Hub control structure 5 which receives information of electricity required by an external electronic device 9 via the data pins 42 and adjusts the electricity storage device 2 for stable output power by means of the power management structure 3.

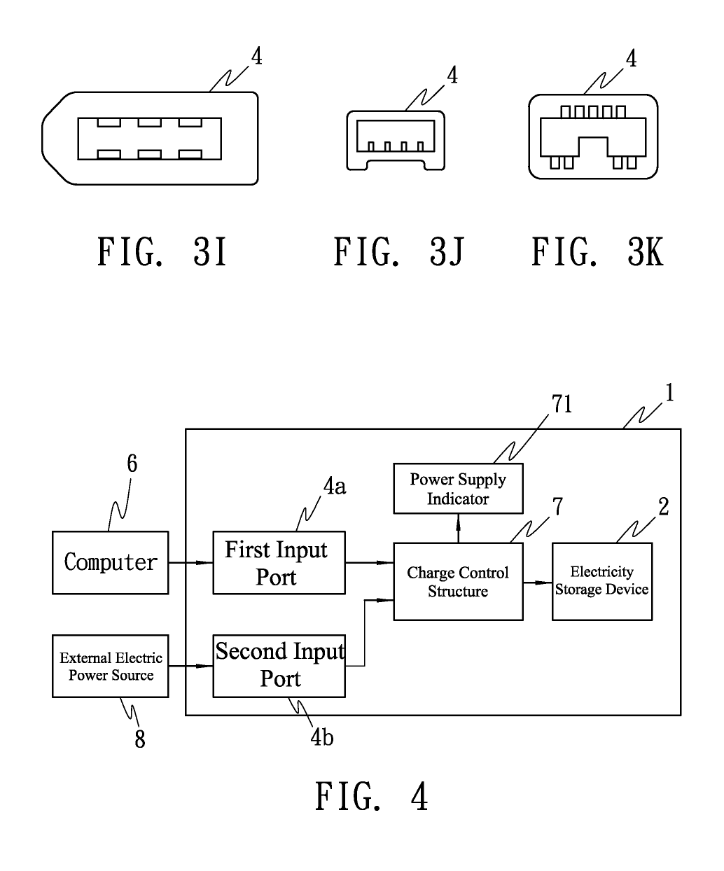

In order to match design of secondary batteries of the electricity storage device 2, the present invention (FIG. 4) without the output port 4 connected to the electronic device 9 could be taken as a charger which depends on a charge control structure 7 to charge secondary batteries in the electricity storage device 2 for contingent use.

For increased stability of output power, there is a buck-and-boost control structure 10 between the electricity storage device 2 and the power management structure 3 which is used to control output of the electricity storage device 2 and supply sufficient stable electricity to each electronic device 9.

In addition, there is a power supply indicator 71 connected to the charge control structure 7 and used in displaying status of the electricity storage device 2 during charge. Similarly, there is a data transfer indicator 51 connected to the Hub control structure 5 and used in displaying status of data transmission. Both the power supply indicator 71 and the data transfer indicator 51 could be LEDs simply which indicate status with ON/OFF light signals.

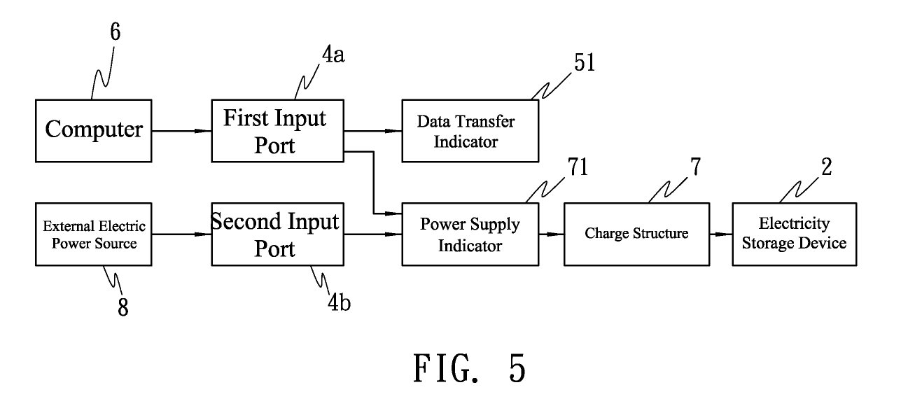

The detailed descriptions about charge are shown in FIG. 5 which illustrates the block diagram of the present invention for charge: the first input port 4a effective in data transmission and charge is connected to the said computer 6; the lightened data transfer indicator 51 implies data transmission ready to work with the said connection to the computer 6 completed; the first input port 4a enables the charge control structure 7 by which a charge is activated and displayed with the lightened power supply indicator 71; the power supply indicator 71 will be off with the charge completed.

The second input port 4b featuring a separate fast charge could be used to link the said external electric source 8 in order to charge the electricity storage device 2 via the charge control structure 7.

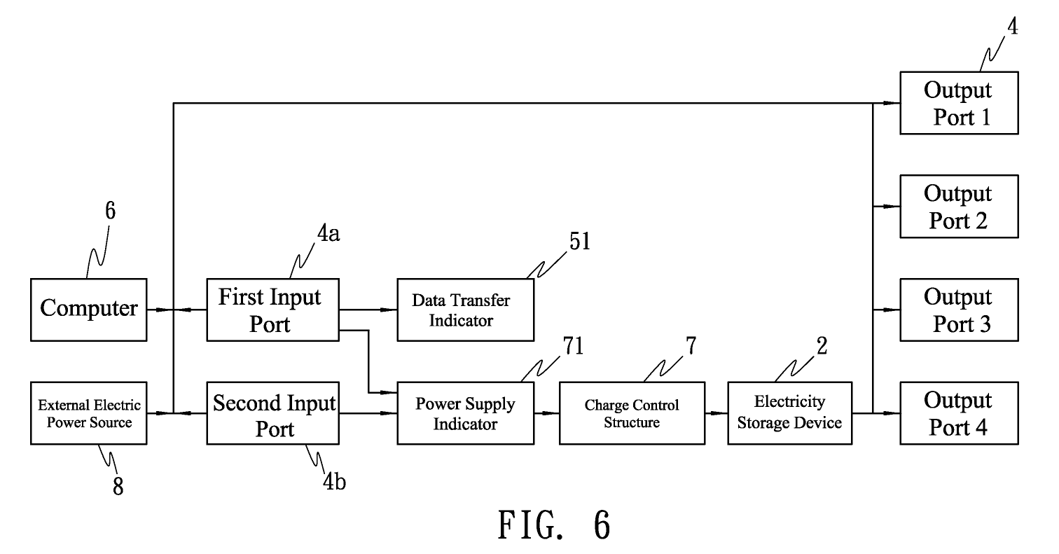

As shown in FIG. 6 of the block diagram for switch to an external electric source, electricity could be supplied to the output port 4 from the external electric source 8 directly in the case of the computer 6 or the external electric source 8 full of electricity, i.e., power consumption of the electronic device 9, which is connected to the output port 4, less than the rated current.

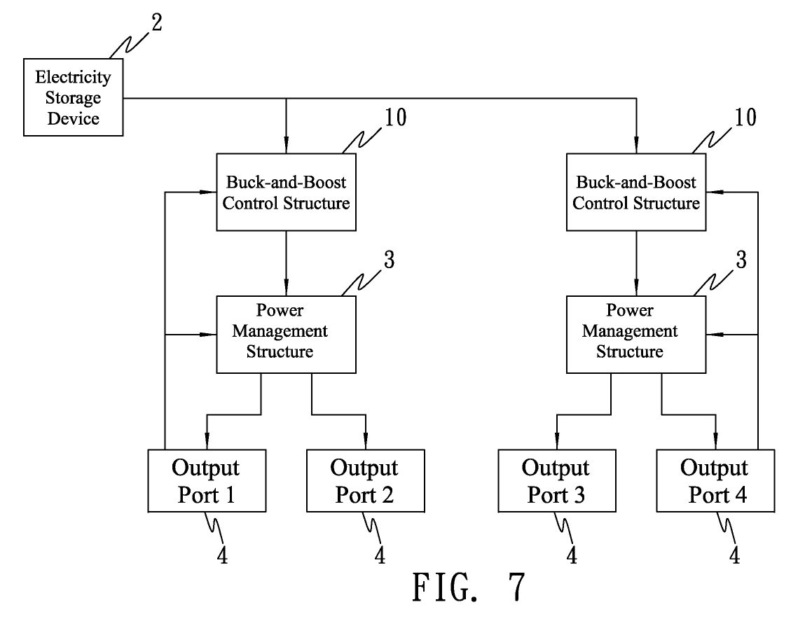

As shown in FIG. 7 of the block diagram for stable power supply structure, the present invention could be inspected by means of circuits, i.e., the power management structure 3, at the output port 4 which links the electronic device 9 prior to charge or data transmission without any resource wasted.

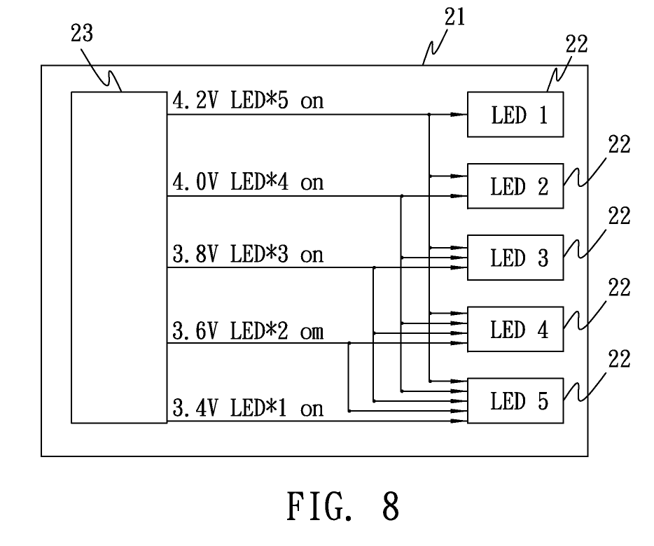

FIG. 8 is the schematic diagram of indicating surplus electricity of the present invention wherein the electricity storage device 2 is connected to a battery indicator 21 on which electricity in the electricity storage device 2 can be read. One method adopted to display electricity is to prepare 5 mutually connecting LEDs 22 controlled by a push switch 23, all of which light up simultaneously during electricity sufficient (i.e., 4.2V as shown in the figure) with the push switch 23 pressed; the lightened LEDs 22 being gradually off during electricity deteriorating can be used to determine electricity held in the electricity storage device 2.

Based on the said descriptions, the mobile backup power supply device with a Hub's functions integrated is able to supply electricity with a stable voltage to the electronic device 9 from the electricity storage device 2 for the electronic device 9 working safely and stably; the power management structure 3 with an intelligent automatic management function during export of electricity is effective in determining and supplying necessary electricity and current necessary to an inserted electronic device 9 via the electricity storage device 2 but terminating output of electricity and current from the electricity storage device 2 without resource wasted if there is no electronic device 9 inserted.

The power management structure 3 with an intelligent automatic management function is able to automatically change output of electricity and current according to realistic demands, for instance, the voltage and current output of the electricity storage device 2 will be adjusted to standard status by the power management structure 3 in order to stabilize an electronic device 9 when information communicated between the computer 6 and the electronic device 9 is detected; in another situation rather than information communication, a large current output from the electricity storage device 2 will be automatically switched by the power management structure 3 in order to rapidly charge the electronic device 9.

Additionally, the power supply of a computer 6 or an external electric source 8 will be automatically switched by the power management structure 3 to make sure of constantly stable running of the electronic device 9 in the event of electricity of the electricity storage device 2 insufficient detected by the power management structure 3.

In contrast to prior arts, the present invention is characteristic of features and efficiency as follows:

1. The present invention is capable of delivering data transmitted between a computer and an external electronic device or between electronic devices.

2. The present invention as a backup power supply of an external electronic device depends on automatic power supply management to charge not less than two electronic devices simultaneously without electricity wasted because of power automatically distributed to each electronic device.

3. The present invention can be taken as one charger for secondary batteries, if necessary, in conformity with environmental protection.

4. Stability of an external electronic device can be effectively maintained owing to power stably supplied to the external electronic device by an electricity storage device.

5. The present invention connected to a computer is able to perform both data transmission and charge in which power is automatically distributed to an external electronic device first or an electricity storage device directly in case of any surplus of power without a computer's electricity wasted that is conformable to environmental protection.

The said detailed descriptions specifically disclose the present invention's feasible embodiment which shall not referred to as an example to confine the claims of the present invention, and any equivalent practice or change without departing from spirits of the present invention shall be included in the appended claims hereunder.

What is claimed is:

1. A mobile backup power supply device with a Hub's functions integrated has features as follows:
A Hub with not less than an input port connected to a computer's power supply or an external power source and not less than an output port connected to an electronic device, both of which are provided with power pins & data pins and allow their data pins to link a Hub control structure for data transmission & management between the computer and the electronic device;
An electricity storage device installed in the Hub; and
A power management structure with an intelligent automatic management function between the electricity storage device and the power pins which receives an electronic device's demand for electricity via data pins and fulfills the electricity storage device's electricity stably and uniformly delivered to the electronic device and the running electronic device safely operated.

2. The mobile backup power supply device with a Hub's functions integrated according to claim 1 wherein the electricity storage device could be primary batteries such as Zinc-Manganese battery, Alkaline-Manganese battery, Zinc-air battery, Mercury battery, Silver Oxide battery, and Lithium battery which can be replaced with the Hub opened during electricity exhausted.

3. The mobile backup power supply device with a Hub's functions integrated according to claim 1 wherein the electricity storage device could be chargeable secondary batteries such as Nickel-Cadmium battery, Nickel-Metal Hydride battery or Lithium Ion battery.

4. The mobile backup power supply device with a Hub's functions integrated according to claim 3 wherein the electricity storage device is connected to a charge control structure which links the computer's power supply or an external electric power source via the input port in order to charge the electricity storage device during electricity exhausted.

5. The mobile backup power supply device with a Hub's functions integrated according to claim 4 wherein the charge control structure is connected to a power supply indicator used to display status of the electricity storage device during charge.

6. The mobile backup power supply device with a Hub's functions integrated according to claim 1 wherein the input port or the output port could be any model within USD ports comprising standard USB A/B, mini USB A/B, micro USB A/B and USB 3.0 A/B.

7. The mobile backup power supply device with a Hub's functions integrated according to claim 1 wherein the input port or the output port could be any model within IEEE 1394 ports comprising IEEE 1394a 6Pin, IEEE 1394a 4Pin and IEEE 1394b 9Pin.

8. The mobile backup power supply device with a Hub's functions integrated according to claim 1 wherein a buck-and-boost control structure installed between the electricity storage device and the power management structure is used to control stability of the electricity storage device's output power.

9. The mobile backup power supply device with a Hub's functions integrated according to claim 1 wherein the Hub control structure is connected to a data transfer indicator used to display status of data transmission.

10. The mobile backup power supply device with a Hub's functions integrated according to claim 1 wherein the electricity storage device is connected to a battery indicator which is controlled by one push switch to indicate electricity held in the electricity storage device with the push switch pressed.

11. A method to use the mobile backup power supply device with a Hub's functions integrated according to claim 1 features:
The mobile backup power supply device with a Hub's functions integrated allows stable electricity to be supplied to an electronic device from the electricity storage device and delivers a running electronic device safely and stably working; the power management structure with an intelligent automatic management function for output of electricity is able to determine electricity and current necessary to an inserted electronic device 9 and supply them via the electricity storage device but terminate output of electricity and current from the electricity storage device 2 in the case of no electronic device 9 inserted.

12. The method to use the mobile backup power supply device with a Hub's functions integrated according to claim 11 wherein the electricity is exported by the internal electricity storage device and the voltage or current output is automatically and adequately changed based on an intelligent automatic management mechanism of the power management structure; the voltage and current output will be adjusted to standard status by the power management structure in order to stabilize work of an electronic device when information communication is detected; on the other hand, a large current output will be automatically switched by the power management structure in order to rapidly charge the electronic device when another situation rather than information communication is detected.

13. The method to use the mobile backup power supply device with a Hub's functions integrated according to claim 11 wherein the power supply of a computer or an external electric source will be automatically switched by the power management structure to make sure of constantly stable running of the electronic device 9 in the event of electricity of the internal electricity storage device insufficient detected by the intelligent automatic management mechanism of the power management structure.
